(19) United States
(12) Patent Application Publication
(10) Pub. No.: US 2009/0327299 A1
(43) Pub. Date: Dec. 31, 2009

(54) REPLICATING MODIFICATIONS MADE TO CONTENTS OF A SHARED FOLDER

(75) Inventors: Eyal SCHWARTZ, Bellevue, WA (US); Yikang XU, Issaquah, WA (US); Matt McCORMICK, Seattle, WA (US); Heather FERGUSON, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,476

(22) Filed: Jun. 26, 2008

(51) Int. Cl. G06F 17/30; G06F 12/00

(52) U.S. Cl. 707/10; 707/201; 707/E17.01; 707/200; 707/E17.032

(57) ABSTRACT

Replicating modifications made to contents of a shared folder. As a part of replicating modifications made to contents of a shared folder, modifications made to a shared folder located on a first computer system and replicated in a second folder that is located on a second computer system are accessed from a second computer system. One or more folders are identified that are associated with the second folder and that are accessible from one or more other computer systems. The one or more folders are caused to have replicated in them modifications that were made to the shared folder.

### BACKGROUND

A peer-to-peer (P2P) network is a type of transient Internet network that allows a group of computer users with the same networking program to connect with each other and directly access files from one another's hard drives. Organizations can use P2P networks as a way for their employees to share files without incurring expenses involved in maintaining a centralized server.

FIG. 1 shows a conventional P2P network that enables two contacts, contact A and contact B, to have shared folders 101 and 103 and 105 and 107 respectively (associated with computers 102 and 104 and 106 and 108), in which both contacts are able to add, delete and edit content and rely on changes they make to sync back to the other contact via a peer-to-peer (P2P) connection. In order for content to be transmitted to one contact's computer from another, both contacts must be online at the same time (which can be problematic, especially when two contacts reside in different time-zones). For that same content to end up on a contact's second computer, the second computer and the transmitting contact's original computer have to be online simultaneously. However, because conventional systems allow a contact to have only one computer online at a time, having content provided to all of a contact's computers using conventional methodologies presents a challenge.

It should be appreciated that while the aforementioned problem may not be a very significant issue for contacts with just one computer, the problem is clearly significant where a contact has multiple computers and multiple contacts. In such cases, the likelihood that a contact can have all of the content that is available from their multiple contacts distributed to all of their computers, as additional contacts having additional computers are added to the schema, is not very high. This is because each computer that a content receiving contact has must be online at the same time as each of the computers in the schema that transmits a modification of a file (not just when the contact is online as an individual) for the file to be successfully synchronized or replicated to all of their computers.

It should be appreciated that such systems are inadequate for the user who uses multiple computers, and who needs to access updated files from each of the computers that he/she uses. Accordingly, conventional systems such as that which is discussed above with reference to FIG. 1 do not effectively accommodate such mobile users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A peer-to-peer (P2P) network allows a group of computer users with the same networking program to connect with each other and directly access files from one another's hard drives when their machines are online at the same time. However, because conventional systems allow a contact to have only one machine online at a time, having content provided to all of a contact's machines, when that contact has more than one machine, using conventional methodologies presents a challenge. A methodology for replicating modifications made to contents of a shared folder that addresses the aforementioned challenges is disclosed. As a part of the disclosed methodology, modifications that are made to the shared folder located on a first computer system and replicated in a second folder located on a second computer system are received at the second computer system. One or more folders are then identified that are associated with the second folder and that are viewable and modifiable from one or more other computer systems. The one or more folders are caused to have replicated therein modifications that were made to the shared folder. For example, if a user working from his/her home computer edits a file in his/her own shared folder, this edit can be propagated to a shared folder on a home computer that is associated with one of the user's contacts, that is left online, via a peer-to-peer connection. Then, the shared folder on the contact's home computer can act as a server and propagate the edits to other folders, on other computers, associated with the contact, for example a PDA or a laptop with which the contact later logs online.

### BRIEF DESCRIPTION OF THE DRAWINGS

The accompanying drawings, which are incorporated in and form a part of this specification, illustrate embodiments and, together with the description, serve to explain the principles of the embodiments:

FIG. 1 shows a conventional peer to peer arrangement between two contacts.

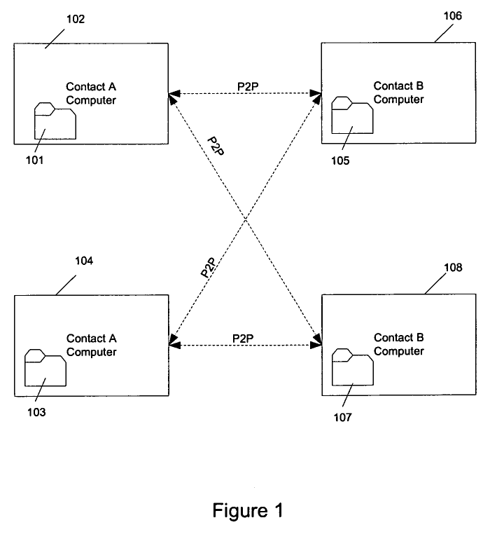

FIG. 2 shows an exemplary operational setting of a system for replicating modifications made to contents of a shared folder according to one embodiment.

FIG. 3 illustrates operations performed in a process for replicating modifications made to contents of a shared folder according to one embodiment.

FIG. 4 shows a system for replicating modifications made to contents of a shared folder according to one embodiment.

FIG. 5 shows a flowchart of the steps performed in a method for replicating modifications according to one embodiment.

FIG. 6 shows an exemplary computing device according to one embodiment.

The drawings referred to in this description should not be understood as being drawn to scale except if specifically noted.

### DETAILED DESCRIPTION

Reference will now be made in detail to various embodiments, examples of which are illustrated in the accompanying drawings. While descriptions will be provided in conjunction with these embodiments, it will be understood that the descriptions are not intended to limit the scope of the embodiments. On the contrary, the disclosure is intended to cover alternatives, modifications and equivalents, of these embodiments. Furthermore, in the following description, numerous specific details are set forth in order to provide a thorough understanding of embodiments. In other instances, well-known methods, procedures, components, and circuits have not been described in detail as not to unnecessarily obscure aspects of embodiments.

### Exemplary Network Setting of System for Replicating Modifications made to Contents of a Shared Folder According to Embodiments

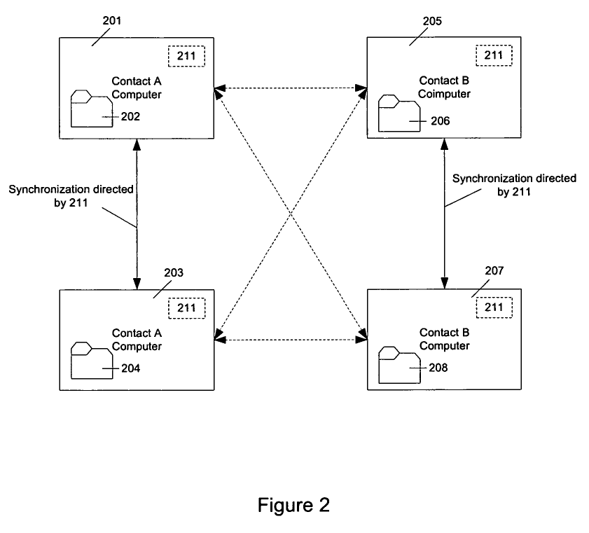

FIG. 2 shows an exemplary operational setting of a system 211 for replicating modifications made to contents of a shared folder according to one embodiment. Because some conventional systems allow a contact to have only one associated computer online at a time, having content provided to all of a contact's associated computers, when that contact has more than one associated computers, using conventional methodologies (that require each computer to be online to receive content) presents a challenge. System 211 overcomes such challenges by enabling modifications made to contents of a shared folder associated with one of a contact's computers to be replicated in one or more other folders that are associated with one or more other computers associated with the contact. FIG. 2 shows computer 201, folder 202, computer 203, folder 204, computer 205, folder 206, computer 207, folder 208, system 211 and contacts A and B.

Referring to FIG. 2, computers 201 and 203 are computers associated with contact A and computers 205 and 207 are computers associated with contact B. It should be appreciated that in one embodiment, although contacts A and B can each be associated with many more other contacts that are associated with many more other computer systems, only the two contacts A and B each being associated with two computers 201 and 203 and 205 and 207 respectively are shown for purposes of clarity and brevity.

Folders 202, 204, 206 and 208 are shared folders that are associated respectively with computers 201, 203, 205 and 207. Accordingly, in one embodiment, folders 202 and 204 and 206 and 208 are related as being associated with associated contacts (contacts whose shared folders are synchronized when modifications such as additions, deletions and edits are made thereto). In one embodiment, folders 202, 204, 206 and 208 are used to contain and present digital files that can be modified by the contact to which they are assigned such that the modifications that are made are replicated in a shared folder of an associated contact so that the shared folders of each of the associated contacts are synchronized. Moreover, in one embodiment, as described herein, modifications that are made to the contents of a shared folder associated with a first contact of associated contacts can not only be replicated in a shared folder associated with a second contact of the associated contacts but also can be automatically replicated by system 211 in other folders associated with the second contact (see detailed discussion below).

System 211 directs the replication of modifications made to contents of a shared folder. In one embodiment, system 211 accesses modifications made to a shared folder which is associated with a first contact and first computer that is replicated in a shared folder associated with a second contact and second computer and causes an additional replication of these modifications in one or more other folders (associated with one or more other computers) associated with the second contact. For example, referring to FIG. 2, if contact A modifies folder 202 and contact B's computer 205 is online at the time such that the modifications that contact A makes to folder 202 can be replicated in folder 206 of contact B's computer 205, system 211 can access these modifications and cause them to be replicated in folder 208 associated with contact B's computer 207. In one embodiment, system 211 can reside on one or more of computers 201, 203, 205 and 207. In another embodiment, system 211 can reside on each one of computers 201, 203, 205 and 207.

It should be appreciated that system 211 enables a contact to have the entirety of a shared folder's content transferred from one computer to other computers if and when the other computers are online. Consequently, the operation of system 211 frees a content receiving contact from a dependence on an associated contact having to use individual peer-to-peer connections of individual computers that are associated with the content receiving contact to transfer modifications to shared folders on each of the individual computers in order to ensure that data is available at locations where the content receiving contact desires.

In one embodiment, system 211 provides a contact's computer with server like functionality (without the associated cost to the business). For example, in one embodiment, a contact's home computer acting as a host for system 211 and a shared folder can be maintained online, while the contact moves from between computers that the contact is associated with throughout the day. In the meantime the shared folder residing on the contact's home computer is available to have any modifications that are made to an associated contact's shared folder replicated to a shared folder thereon and accessed by system 211 which then can propagate the modifications to folders residing on the other computers that are associated with the contact. The result is a more robust sharing folders environment where a given contact is more likely to receive modifications that an associated contact makes (as their total time online increases) to a shared folder and have those changes propagated to each of the contact's computers.

Exemplary embodiments are contrasted with systems that are based on the paradigm that views a contacts presence, and online or offline status, in terms of the contact's person, and not in terms of their computer's online status. In exemplary embodiments, although a contact is away from a computer or is otherwise preoccupied, if this computer is online and receives content, this content can be replicated on each of the computers that are associated with the contact. Accordingly, a contact who has three computers does not have to be present online on their three different computers in order to get a document from an associated contact onto the three computers.

### Operation

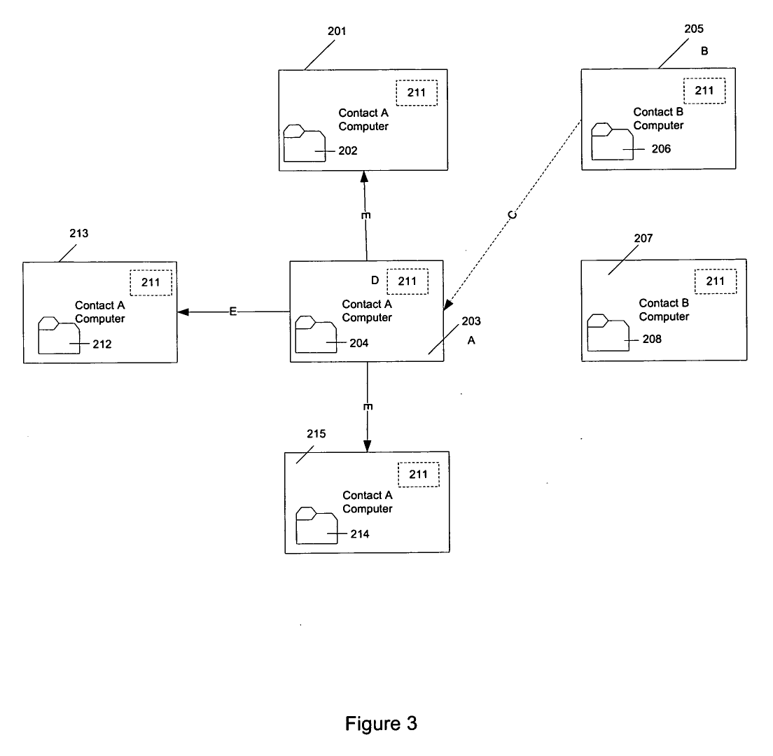

FIG. 3 illustrates operations A-E performed in a process for replicating modifications made to contents of a shared folder according to one embodiment. These operations including the order in which they are presented are only exemplary. In other embodiments, other operations in other orders can be included. In addition to the structures shown in FIG. 2, FIG. 3 shows computers 213 and 215, and corresponding folders 212 and 214 that are associated with contact A.

At A, contact logs computer 203 on and leaves the computer on in his/her absence.

Referring to FIG. 3, at B, contact B makes a modification to shared folder 206 on computer 205.

At C, the modification to shared folder 206 is replicated in shared folder 204.

At D, system 211 accesses the modifications that are made to shared folder 206 and that are replicated in shared folder 204.

At E, system 211 causes the modifications that are made to the shared folder 206 and replicated in folder 204 on computer 203 associated with contact A to be replicated in folders 203, 212 and 214 on computers 201, 213 and 215 associated with contact A.

In the above discussion computer system 203, even though not “active” (e.g., contact A is not interacting with it), provides a useful function, almost like a personal server, which allows contact A to sign in and out of many other computer systems such as computers 201, 213 and 215, knowing that that computer 203 will operate to receive content (modifications to the shared folders) and distribute it to all of their other computers that come online.

It should be appreciated that in one embodiment the aforementioned server-like status that computer 203 has in the FIG. 3 example can be transient, and can be shifted from one computer to another without the necessity for any user action, other than signing the computer in and leaving it signed on. In one embodiment, because a contact's computer remains online, and is automatically able to make connections with both other computers associated with its user, and computers associated with associated contacts, system 211 is able to access modifications made to shared folders and direct the transfer of data to other computers accordingly.

### Components of System for Replicating Modifications made to Contents of a Shared Folder According to Embodiments

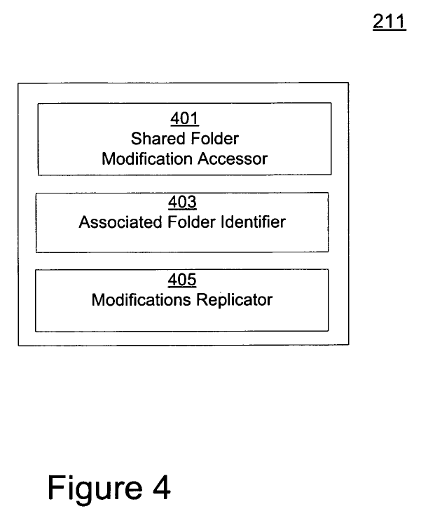

FIG. 4 shows components of a system 211 for replicating modifications made to contents of a shared folder according to one embodiment. In one embodiment, system 211 implements an algorithm for replicating modifications made to contents of a shared folder. In the FIG. 4 embodiment, system 211 includes shared folder modification accessor 401, associated folder identifier 403 and modifications replicator 405.

It should be appreciated that the aforementioned components of system 211 can be implemented in hardware or software or in a combination of both. In one embodiment, components and operations of system 211 can be encompassed by components and operations of one or more computer programs (e.g., a program on a computer system). In another embodiment, components and operations of system 211 can be separate from the aforementioned one or more computer programs but can operate cooperatively with components and operations thereof.

Referring to FIG. 4, shared folder modification accessor 401 accesses modifications that are made to a shared folder located on a computer associated with a content transferring contact and that are replicated in a shared folder on a computer associated with a content receiving contact. In one embodiment, the modifications are accessed by modifications accessor 401 from a transmission from the computer associated with the content transferring contact. In one embodiment, the modifications are retrieved by modifications accessor 401 from the computer that is associated with the content receiving contact.

Associated folder identifier 403 identifies one or more folders that are associated with the shared folder that is associated with the content receiving contact. In one embodiment, the one or more folders are accessible from one or more computers that are different from the computer where the shared folder that is associated with the content receiving contact is located. In one embodiment, the one or more different computers are all associated with the content receiving contact.

Modifications replicator 405 causes the identified one or more folders to have replicated therein the modifications made to the shared folder that is associated with the content receiving contact. In one embodiment, the modifications can include but are not limited to the addition, deletion and editing of folder content.

### Exemplary Flowchart of Method for Replicating Modifications made to Contents of a Shared Folder According to Embodiments

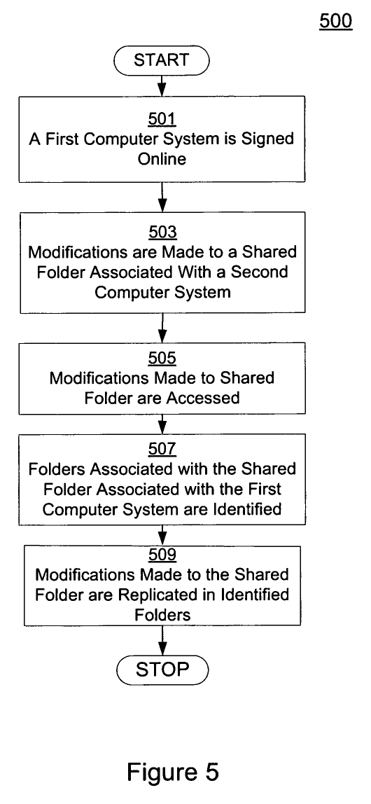

FIG. 5 shows a flowchart 500 of the steps performed in a method for replicating modifications made to contents of a shared folder according to one embodiment. The flowchart includes processes that, in one embodiment can be carried out by processors and electrical components under the control of computer-readable and computer-executable instructions. Although specific steps are disclosed in the flowcharts, such steps are exemplary. That is the present invention is well suited to performing various other steps or variations of the steps recited in the flowcharts. Within various embodiments, it should be appreciated that the steps of the flowcharts can be performed by software, by hardware or by a combination of both.

Referring to FIG. 5, at 501, a first computer is signed on (online) by a contact who has at least one associated contact.

At 503, modifications are made to a shared folder associated with a second computer by a contact associated with the contact that signed the first computer online in step 501.

At 505, modifications made to the shared folder associated with the second computer system (content transferring computer) are accessed. In one embodiment, the modifications are transferred to a shared folder associated with the first computer signed online at 501 (the content receiving computer).

At 507, one or more folders are identified that are associated with the shared folder associated with the first computer system that are accessible from one or more other computer systems. In one embodiment, the one or more folders are associated with one are more computers that can be associated with the same contact.

At 509, the identified one or more folders are caused to have replicated therein the modifications made to the shared folder that is associated with the first computer system. In one embodiment, the modifications can include but are not limited to the addition, deletion and editing of folder content.

### Exemplary Hardware Operating Environment of System for Replicating Modifications made to Contents of a Shared Folder According to One Embodiment

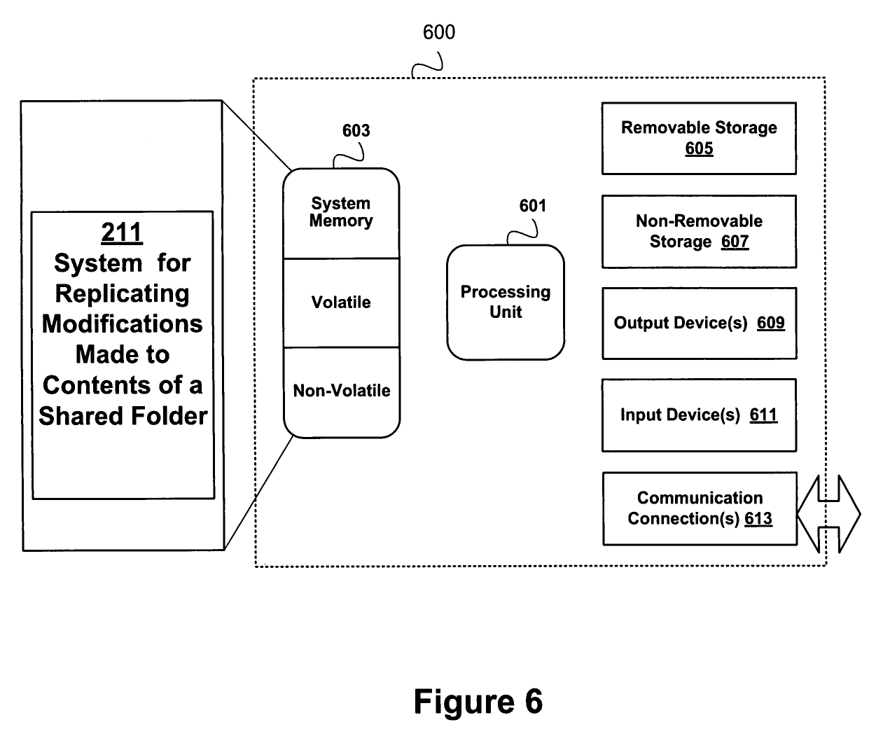

FIG. 6 shows an exemplary computing device 600 according to one embodiment. Referring to FIG. 6, computing device 600 can be included as a part of a computer (e.g., computers 201, 203, 205 and 207 in FIG. 2) in accordance with one embodiment. Computing device 600 typically includes at least some form of computer readable media. Computer readable media can be any available media that can be accessed by computing device 600 and can include but is not limited to computer storage media.

In its most basic configuration, computing device 600 typically includes processing unit 601 and system memory 603. Depending on the exact configuration and type of computing device 600 that is used, system memory 603 can include volatile (such as RAM) and non-volatile (such as ROM, flash memory, etc.) elements or some combination of the two. In one embodiment, as shown in FIG. 6, a system 211 for replicating contents of a shared folder (see description of 211 made with reference to FIG. 2) can reside in system memory 603.

Additionally, computing device 600, can include mass storage systems (removable 605 and/or non-removable 607) such as magnetic or optical disks or tape. Similarly, computing device 600 can include input devices 611 and/or output devices 609 (e.g., such as a display). Additionally, computing device 600 can include network connections 613 to other devices, computers, networks, servers, etc. using either wired or wireless media. As all of these devices are well known in the art, they need not be discussed in detail.

With reference to exemplary embodiments thereof, replicating modifications made to contents of a shared folder is disclosed. As a part of replicating modifications made to contents of a shared folder, modifications made to a shared folder located on a first computer system and replicated in a second folder that is located on a second computer system are accessed from a second computer system. One or more folders are identified that are associated with the second folder and that are accessible from one or more other computer systems. The one or more folders are caused to have replicated in them modifications that were made to the shared folder.

The foregoing descriptions of specific embodiments have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for replicating modifications made to contents of a shared folder, comprising:
accessing modifications that are made to a shared folder located on a first computer system and replicated in a second folder located on a second computer system;
identifying one or more folders, associated with said second folder, that are accessible from one or more other computer systems;
causing said one or more folders to have replicated therein said modifications made to said shared folder.

2. The method of claim 1 wherein said modifications made to said shared folder are accessed by said second computer system and are transmitted from said second computer system to one or more related computer systems when said one or more computer system are online.

3. The method of claim 2 wherein said first computer system is controlled by a contact of a user of said second computer system.

4. The method of claim 3 wherein said second computer system and said one or more other computer systems are controlled by said user.

5. The method of claim 1 wherein each of said first computer system, second computer system and said one or more computer systems can cause the content of folders resident on each to be replicated to folders that are associated with other computer systems.

6. The method of claim 1 wherein changes made in a folder residing on said second computer system are caused to be replicated in a folder residing on said first computer system.

7. The method of claim 1 wherein said modifications are selected from the group consisting of adding, deleting, and editing contents of said shared folder.

8. A method for synchronizing one or more folders with a shared folder, comprising:
determining modifications made to a shared folder located on a first computer system from a second computer system;
synchronizing a second folder that is located on said second computer system with said shared folder by replicating the modifications made to said shared folder in said second folder;
determining one or more folders, associated with said second folder, that are accessible from one or more other computer systems;
synchronizing said one or more folders with said second folder by replicating therein said modifications replicated in said second folder.

9. The method of claim 8 wherein said modifications made to said shared folder are accessed by said second computer system and are transmitted from said second computer system to one or more related computer systems when said one or more computer systems are online.

10. The method of claim 9 wherein said first computer system is controlled by a contact of a user of said second computer system.

11. The method of claim 9 wherein said second computer system and said one or more other computer systems are associated with the same user.

12. The method of claim 8 wherein each of said second computer system and said one or more computer systems can have modifications to folders resident on each replicated in folders associated with other computer systems.

13. The method of claim 8 wherein changes made in a folder residing on said second computer system are caused to be replicated in a folder residing on said first computer system.

14. The method of claim 8 wherein said modifications are selected from the group consisting of adding, deleting, and editing contents of said shared folder.

15. A computer-readable medium having computer-executable components, comprising:
a modification accessing component for accessing modifications made to a shared folder located on a first computer system from a second computer system;
a modifications replicating component for replicating the modifications in a second folder located on said second computer system;
a folder identifying component for identifying one or more folders, associated with said second folder, that are accessible from one or more other computer systems; and
a synchronizing component for causing said one or more folders to have replicated therein said modifications made to said shared folder.

16. The medium of claim 15 wherein said modifications made to said shared folder are accessed by said second computer system and are transmitted from said second computer system to one or more related computer systems when said one or more computer system are online.

17. The medium of claim 16 wherein said first computer system is controlled by a contact of a user of said second computer system.

18. The medium of claim 17 wherein said second computer system and said one or more other computer systems are controlled by said user.

19. The medium of claim 15 wherein each of said second computer system and said one or more computer systems can cause folders resident on each to replicated in folders associated with other computer systems.

20. The medium of claim 15 wherein said modifications are selected from the group consisting of adding, deleting, and editing contents of said shared folder.
